(19) United States
(12) Patent Application Publication
(10) Pub. No.: US 2026/0045071 A1
(43) Pub. Date: Feb. 12, 2026

(54) METHOD FOR RECREATING TRAINED MODEL, SYSTEM FOR RECREATING TRAINED MODEL, AND PROGRAM FOR RECREATING TRAINED MODEL

(71) Applicant: SHIMADZU CORPORATION, Kyoto-shi (JP)

(72) Inventors: Hiroaki TSUSHIMA, Kyoto-shi (JP); Ryo TAKAHASHI, Kyoto-shi (JP); Sora SUGIYAMA, Kyoto-shi (JP)

(21) Appl. No.: 19/296,484

(22) Filed: Aug. 11, 2025

(30) Foreign Application Priority Data
Aug. 9, 2024 (JP) 2024-134657

(51) Int. Cl. G06V 10/776; G06T 7/00; G06V 10/774

(52) U.S. Cl. CPC G06V 10/776; G06T 7/0004; G06V 10/774; G06T 2207/10116; G06T 2207/20081; G06T 2207/30148

(57) ABSTRACT

In this method for recreating a trained model, a first trained model 31a is a general-purpose trained model corresponding to a plurality of types of inspection objects 90. The method comprises a step of obtaining a first inference result 50a, obtained by inputting an X-ray image 40 into the trained model 31 for any X-ray image 40 of the plurality of types of inspection objects 90; a step of obtaining a first corrected inference result 51a by correcting the first inference result 50a; a step of storing the first corrected inference results 51a for the plurality of types of inspection objects 90 in association with their respective X-ray images 40; and a step of recreating the first trained model 31a using the associatedly stored X-ray images 40 and first corrected inference results 51a.

### TECHNICAL FIELD

The present invention relates to a method for recreating a trained model, a system for recreating a trained model, and a program for recreating a trained model, and more particularly, to a method for recreating a trained model, a system for recreating a trained model, and a program for recreating a trained model that is used for analyzing X-ray images.

### BACKGROUND ART

Conventionally, an apparatus is known that analyzes X-ray images using a trained model (see, for example, Patent Literature 1).

The aforementioned Patent Literature 1 discloses an X-ray imaging system that identifies at least one of a region of an inspection object and a region of an abnormal part included in the inspection object, using a trained model. The X-ray imaging system disclosed in Patent Literature 1 includes a fluoroscopy device and an analysis device. In the configuration disclosed in Patent Literature 1, an X-ray image generated by imaging an inspection object with the fluoroscopy device is analyzed by the analysis device. Specifically, in the configuration disclosed in Patent Literature 1, the analysis device is configured to identify the region of the inspection object by inputting the X-ray image into the trained model.

### CITATION LIST

### Patent Literature

[Patent Literature 1] Japanese Unexamined Patent Application Publication No. 2024-029975

### SUMMARY OF THE INVENTION

### Technical Problem

Although not described in Patent Literature 1, the trend in the types of components and the like mounted on an inspection object may change with market changes. When a change in the trend of the types of components and the like mounted on the inspection object occurs, the accuracy of the inference results of the inspection object by the trained model decreases due to the difference between the X-ray images used as training data when the trained model was generated and the X-ray images at the time of actual inspection.

The present invention has been made to solve the above-described problem, and one object of the present invention is to suppress a decrease in the accuracy of the inference results of an inspection object by a trained model, even when a change occurs in the trend of the types of components and the like mounted on the inspection object.

### Solution to Problem

A method for recreating a trained model for acquiring a region of an inspection object from an X-ray image of the inspection object, wherein the trained model is a general-purpose first trained model corresponding to a plurality of types of inspection objects, the method comprising: a step of acquiring an X-ray image; a step of obtaining a first inference result of the region of the inspection object by inputting the X-ray image into the first trained model for any X-ray image of the plurality of types of inspection objects; a step of obtaining a first corrected inference result by correcting the first inference result based on a user's operation input; a step of storing the first corrected inference results for the plurality of types of inspection objects in association with their respective X-ray images; and a step of recreating the first trained model using the associatedly stored X-ray images and first corrected inference results for the plurality of types of inspection objects. The term “recreating a trained model” is a concept that includes newly creating a trained model using only new training data, newly creating a trained model using both new training data and training data that has already been used for training, and performing training again on an already created trained model using new training data.

### Advantageous Effects of Invention

Since the first inference result contains some errors, appropriate correction by user operation is necessary. By storing this first corrected inference result, the stored first corrected inference result can be used to recreate the first trained model. In other words, the execution of the inspection of the inspection object also serves as the creation of training data necessary for recreating a new first trained model. Therefore, the user is not required to separately perform the task of creating training data necessary for recreating a new first trained model, and the first trained model can be recreated while reducing the burden on the user.

Furthermore, the first trained model is a general-purpose trained model, which is created by inputting a plurality of types of inspection objects as training data. However, since the types of inspection objects that the user inspects may change over time (the trend changes), the accuracy of the first inference result by the general-purpose trained model (first trained model) decreases. However, in the present invention, the first corrected inference results for a plurality of types of inspection objects are stored, and the first trained model is recreated using the plurality of types of stored first corrected inference results. Since the first corrected inference results used for recreation are for a plurality of types of inspection objects for which the process of outputting the first inference result was actually executed (i.e., the inspection was executed), the recreated general-purpose trained model is considered to be more suitable for the plurality of types of inspection objects that the user will continue to inspect. Therefore, by using the recreated general-purpose trained model, the accuracy of the first inference result can be improved.

### BRIEF DESCRIPTION OF THE DRAWINGS

FIG. 1 is a block diagram showing the overall configuration of an X-ray imaging system according to an embodiment of the present invention.

FIG. 2 is a diagram showing an example of an inspection object.

FIG. 3 is a block diagram for explaining the functional configuration of a control unit.

FIG. 4 is a diagram showing an example of an X-ray image.

FIG. 5 is a diagram for explaining a configuration for generating a trained model and a configuration for analyzing an X-ray image using the trained model.

FIG. 6 is a diagram for explaining an inference result output by the trained model.

FIG. 7 is an enlarged view of a part of the inference result.

FIG. 8 is a diagram for explaining correction locations in the inference result.

FIG. 9 is a diagram for explaining a corrected inference result.

FIG. 10 is a diagram for explaining a configuration in which the control unit obtains a first corrected inference result from an X-ray image.

FIG. 11 is a diagram for explaining a configuration in which the control unit obtains a second corrected inference result from an X-ray image.

FIG. 12 is a diagram for explaining a configuration in which the control unit recreates a first trained model.

FIG. 13 is a diagram for explaining a configuration in which the control unit recreates a second trained model.

FIG. 14 is a diagram showing an example of a screen for confirming an inference result.

FIG. 15 is a diagram showing an example of a trained model management screen.

FIG. 16 is a flowchart for explaining the process of recreating the first trained model.

FIG. 17 is a flowchart for explaining the process of recreating the second trained model.

### DESCRIPTION OF EMBODIMENTS

Hereinafter, an embodiment embodying the present invention will be described based on the drawings.

### (Overall Configuration of X-Ray Imaging System)

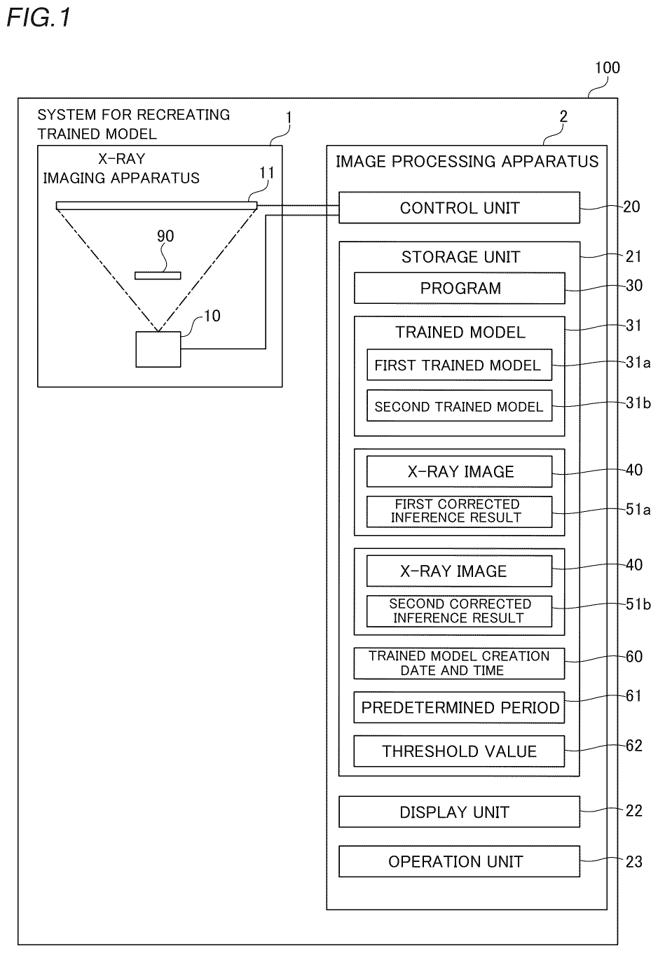

With reference to FIG. 1 to FIG. 17, a trained model recreation system 100 according to an embodiment of the present invention will be described.

As shown in FIG. 1, the trained model recreation system 100 according to the present embodiment is a trained model recreation system for recreating a trained model 31 for acquiring a region of an inspection object 90 from an X-ray image 40 of the inspection object 90. The trained model 31 is used, for example, for analyzing an X-ray image 40 that images the inside of an inspection object 90 as an object for non-destructive inspection purposes.

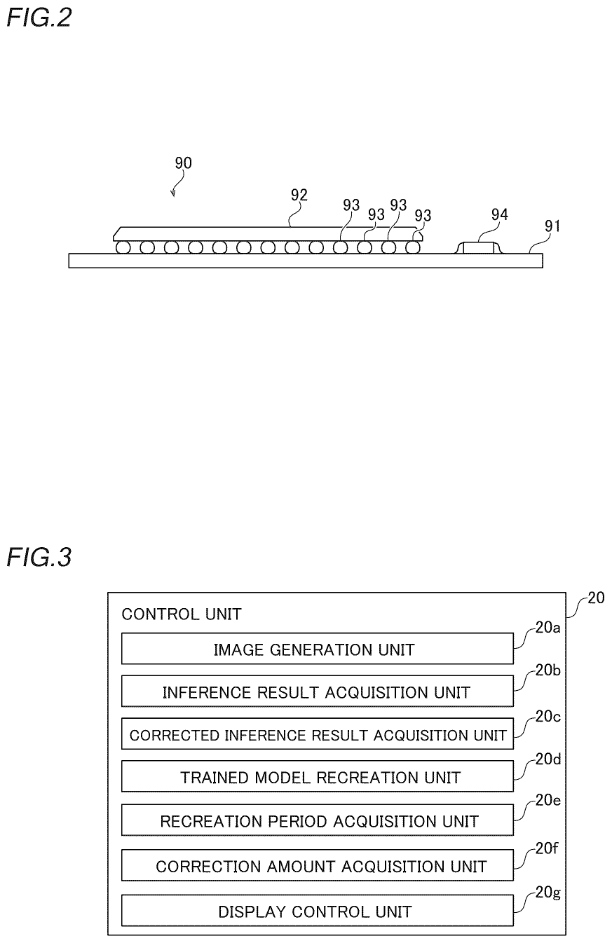

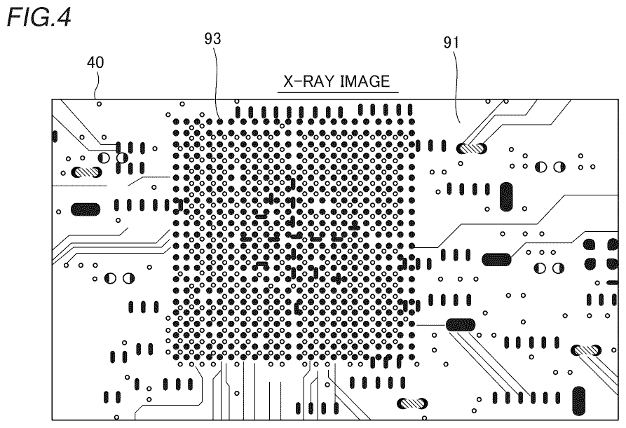

As shown in FIG. 2, the inspection object 90 is an electronic device including a substrate 91. Electronic components 92 are mounted on the substrate 91. The electronic components 92 are electrically connected to the substrate 91 by a plurality of solder balls 93 (bumps). The plurality of solder balls 93 are arranged in a state having regularity. Specifically, the plurality of solder balls 93 are arranged in a grid pattern on the substrate 91 so as to have regularity. That is, the electronic component 92 is connected to the substrate 91 by a BGA (Ball Grid Array). A plurality of solder balls 93 are arranged side by side on one surface of the substrate 91. The electronic component 92 includes, for example, an electronic circuit such as an IC (Integrated Circuit). In the trained model recreation system 100, an analysis of an X-ray image 40 (see FIG. 4) used for non-destructive inspection for abnormalities such as voids and bridges of the plurality of solder balls 93 is performed. Furthermore, on the substrate 91, in addition to the electronic component 92, electronic components 94 such as surface-mounted resistors or capacitors are mounted.

As shown in FIG. 1, the trained model recreation system 100 includes an X-ray imaging apparatus 1 and an image processing apparatus 2. The X-ray imaging apparatus 1 performs X-ray imaging on the inspection object 90. The image processing apparatus 2 generates an X-ray image 40. The image processing apparatus 2 also performs analysis processing using the trained model 31 on the generated X-ray image 40. The image processing apparatus 2 also recreates the trained model 31. The X-ray imaging apparatus 1 and the image processing apparatus 2 each have a communication module, and transmit and receive information to and from each other via a network or the like.

The X-ray imaging apparatus 1 has an X-ray irradiation unit 10 and an X-ray detector 11. The X-ray irradiation unit 10 is configured to irradiate X-rays. In the present embodiment, the X-ray irradiation unit 10 irradiates X-rays to the inspection object 90 including the plurality of solder balls 93. The X-ray irradiation unit 10 includes an X-ray tube that irradiates X-rays by being supplied with power from a power supply device (not shown).

The X-ray detector 11 is configured to detect the X-rays irradiated from the X-ray irradiation unit 10. The X-ray detector 11 outputs an electrical signal corresponding to the detected X-rays. The X-ray detector 11 includes, for example, an FPD (Flat Panel Detector), which is a detector of X-rays. The X-ray irradiation unit 10 and the X-ray detector 11 are arranged inside a housing (not shown) of the X-ray imaging apparatus 1.

As shown in FIG. 1, the image processing apparatus 2 has a control unit 20 and a storage unit 21. The image processing apparatus 2 is, for example, a personal computer communicably connected to the X-ray imaging apparatus 1. The control unit 20 controls the operation of each part of the X-ray imaging apparatus 1. The control unit 20, for example, controls the irradiation of X-rays by the X-ray irradiation unit 10 by controlling a power supply device (not shown). The control unit 20 includes a processor or circuitry such as a CPU (Central Processing Unit), and a ROM (Read Only Memory), a RAM (Random Access Memory), and the like. The control unit 20 may also include a processor such as a GPU (Graphics Processing Unit) or an FPGA (Field-Programmable Gate Array) configured for image processing.

The storage unit 21 is configured to store various programs 30 to be executed by the control unit 20, and parameters. The storage unit 21 includes, for example, a non-volatile memory such as an HDD (Hard Disk Drive) or an SSD (Solid State Drive). The program 30 is an example of the “program for recreating a trained model” in the claims.

The storage unit 21 also stores a first trained model 31a, a second trained model 31b, a first corrected inference result 51a, a second corrected inference result 51b, a trained model creation date and time 60, a predetermined period 61, and a threshold value 62. The first trained model 31a is an example of the “trained model” in the claims.

Furthermore, a display unit 22 and an operation unit 23 are connected to the image processing apparatus 2. The display unit 22 includes, for example, a liquid crystal monitor. The display unit 22 displays images and character information under the control of the control unit 20. The operation unit 23 receives input operations from an operator. The operation unit 23 includes, for example, a keyboard and a pointing device such as a mouse. The operation unit 23 outputs an operation signal based on the received input operation to the control unit 20.

As shown in FIG. 3, the control unit 20 includes, as functional blocks, an image generation unit 20a, an inference result acquisition unit 20b, a corrected inference result acquisition unit 20c, a trained model recreation unit 20d, a recreation period acquisition unit 20e, a correction amount acquisition unit 20f, and a display control unit 20g. These are configured as software functional blocks realized by the control unit 20 executing a program 30 (see FIG. 1) stored in the storage unit 21 (see FIG. 2). In other words, the program 30 is configured to cause a computer (the control unit 20) to execute each control performed by the functional blocks 20a to 20g. Note that these functional blocks 20a to 20g may also be configured by providing dedicated processors (processing circuits) and being constituted by mutually individual hardware.

The image generation unit 20a generates an X-ray image 40 (see FIG. 4) based on the X-rays detected by the X-ray detector 11 (see FIG. 1).

### (X-Ray Image)

As shown in FIG. 4, the X-ray image 40 is an image showing the substrate 91. Specifically, the X-ray image 40 shows the plurality of solder balls 93 arranged in a grid pattern with regularity on the substrate 91.

### (Trained Model)

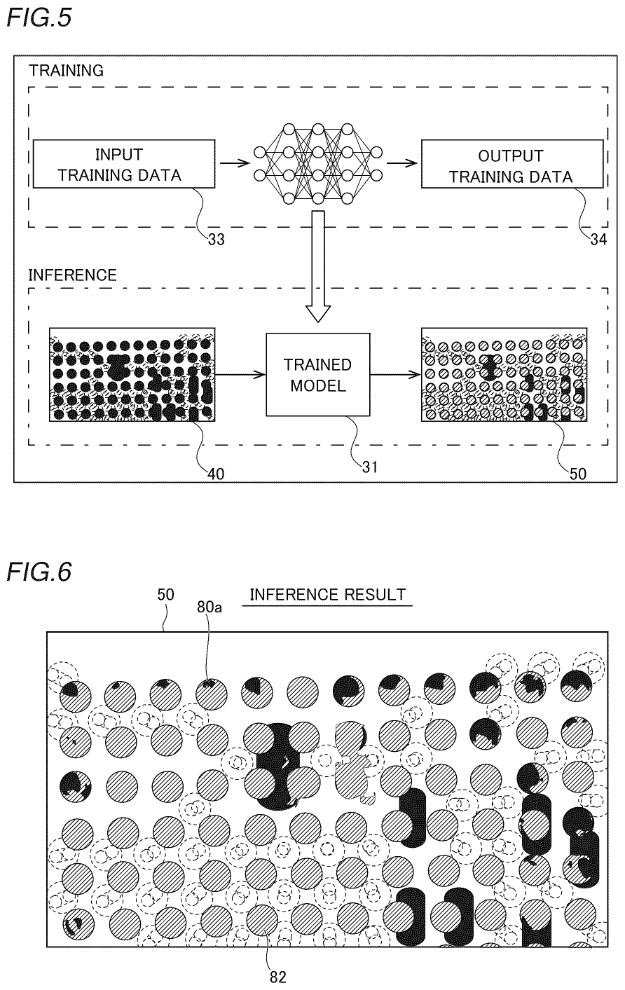

With reference to FIG. 5, the analysis performed by the first trained model 31a and the second trained model 31b, and the generation and recreation of the first trained model 31a and the second trained model 31b will be described. Common parts of the first trained model 31a and the second trained model 31b will be described as the trained model 31. As shown in FIG. 5, the trained model 31 is used for the analysis of the X-ray image 40. Specifically, the trained model 31 is used to identify a solder ball region 80a (see FIG. 6), which is a region of the solder balls 93 (see FIG. 4). In other words, the region of the inspection object 90 is the solder ball region 80a where the plurality of solder balls 93 are shown. The trained model 31 is generated by the image processing apparatus 2 (see FIG. 1) or a computer different from the image processing apparatus 2 and is stored in advance in the storage unit 21 (see FIG. 1).

Furthermore, as shown in FIG. 5, the trained model 31 is generated by machine learning with a dataset of input training data 33 and output training data 34. The input training data 33 is generated based on a training X-ray image (not shown). The recreation of the trained model 31 is also performed based on the input training data 33 and the output training data 34, similar to the generation of the trained model 31. The training X-ray image, similar to the X-ray image 40 (see FIG. 4) to be analyzed, is captured by the X-ray imaging apparatus 1 (see FIG. 1) and generated by the image processing apparatus 2. The X-ray image 40 to be analyzed and the training X-ray image for generating the trained model 31 are images including an inspection object 90 (solder balls 93) having a common structure.

The output training data 34 is generated by applying a label 82 (see FIG. 6) to the region where the solder balls 93 are shown in the training X-ray image. When recreating the trained model 31, an inference result 50 or a corrected inference result 51 (see FIG. 9) output by the trained model 31 is used as the output training data 34.

The trained model 31 is generated by machine learning using deep learning. The deep learning includes, for example, machine learning based on U-Net, which is a type of Fully Convolutional Network (FCN). The trained model 31 is generated by training it to perform image transformation (image reconstruction) that can distinguish between a region of solder balls 93 (solder ball region 80a) and a background region other than the solder balls 93 for each pixel in each of the input X-ray images 40.

As shown in FIG. 5, the trained model 31 is configured to output an inference result 50 when an X-ray image 40 is input. The inference result 50 is a label image in which the region of the solder balls 93 (solder ball region 80a (see FIG. 6)) in the X-ray image 40 is labeled with a label 82, thereby distinguishing the solder ball region 80a from other regions.

### (Inference Result)

FIG. 6 shows an example of an inference result 50. Common parts of the first inference result 50a and the second inference result 50b will be described as the inference result 50. The inference result 50 is an image in which a label 82 is applied to the solder ball region 80a. When an X-ray image 40 (see FIG. 4) is input to the trained model 31 (see FIG. 1), it extracts the region of the inspection object 90 (solder ball region 80a) included in the X-ray image 40. Then, the trained model 31 outputs the inference result 50, which is an image with the label 82 applied to the extracted solder ball region 80a. That is, the inference result 50 is an overlay image in which the label 82 is superimposed on the X-ray image 40.

### (Correction of Inference Result)

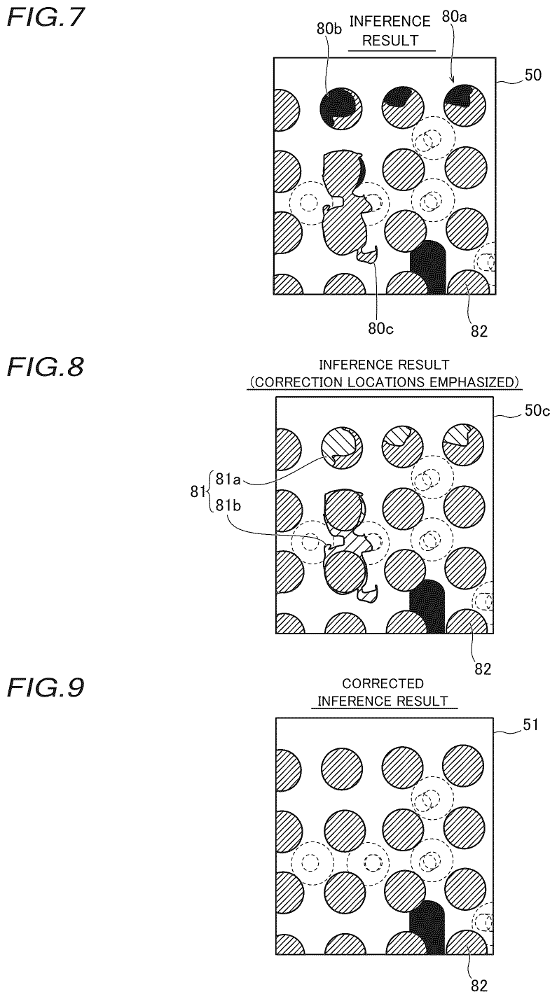

FIG. 7 is an enlarged image of a part of the inference result 50. If the inference accuracy of the trained model 31 (see FIG. 5) is low, a region where the label 82 is not applied within the solder ball region 80a (non-label-superimposed region 80b) and a region where the label 82 is applied at a position other than the solder ball region 80a (label deviation region 80c) may occur. If the trained model 31 is recreated using the inference result 50 in which the non-label-superimposed region 80b and the label deviation region 80c have occurred, the inference accuracy of the recreated trained model 31 will decrease. Therefore, in the present embodiment, the corrected inference result acquisition unit 20c (see FIG. 3) is configured to correct the inference result 50.

Specifically, as shown in the inference result 50c of FIG. 8, the corrected inference result acquisition unit 20c adds a missing label 82 or deletes an unnecessary label 82 for a correction region 81. The correction region 81 includes a non-superimposed label correction region 81a corresponding to the non-label-superimposed region 80b (see FIG. 7) and a deviation label correction region 81b corresponding to the label deviation region 80c (see FIG. 7). The non-superimposed label correction region 81a is a region where it is necessary to add the label 82. The deviation label correction region 81b is a region where it is necessary to delete the label 82. In FIG. 8, hatching is applied to the non-superimposed label correction region 81a and the deviation label correction region 81b for convenience, but in the actual inference result 50, hatching is not applied to the non-superimposed label correction region 81a and the deviation label correction region 81b.

In the present embodiment, the corrected inference result acquisition unit 20c obtains a corrected inference result 51 shown in FIG. 9 based on a user's operation input. Specifically, when the corrected inference result acquisition unit 20c receives a user's operation input to add a label 82 to a region corresponding to the solder ball region 80a, it adds the label 82 to the non-superimposed label correction region 81a. Furthermore, when the corrected inference result acquisition unit 20c receives a user's operation input to delete an unnecessary label 82 from the label deviation region 80c, it deletes the label 82 in the deviation label correction region 81b.

The corrected inference result acquisition unit 20c obtains the corrected inference result 51 shown in FIG. 9 by correcting the correction region 81 based on the user's operation input. Common parts of the first corrected inference result 51a and the second corrected inference result 51b will be described as the corrected inference result 51. The corrected inference result 51 is an overlay image in which the non-label-superimposed region 80b and the label deviation region 80c are not included for the solder ball region 80a. Note that if the user allows it, the corrected inference result 51 may include the non-label-superimposed region 80b and the label deviation region 80c.

### (First Trained Model and Second Trained Model)

The first trained model 31a is a general-purpose trained model capable of outputting a first inference result 50a corresponding to a plurality of types of inspection objects 90. That is, the first trained model 31a is a trained model created so that it can output a first inference result 50a, which is an inference result 50 of the corresponding inspection object 90, even when an X-ray image 40 of any of the plurality of types of inspection objects 90 is input. The first inference result 50a is an example of the “inference result” in the claims.

The second trained model 31b is a dedicated trained model capable of outputting a second inference result 50b corresponding to a specific one type of inspection object 90 among the plurality of types of inspection objects 90. A second trained model 31b is provided for each type of inspection object 90.

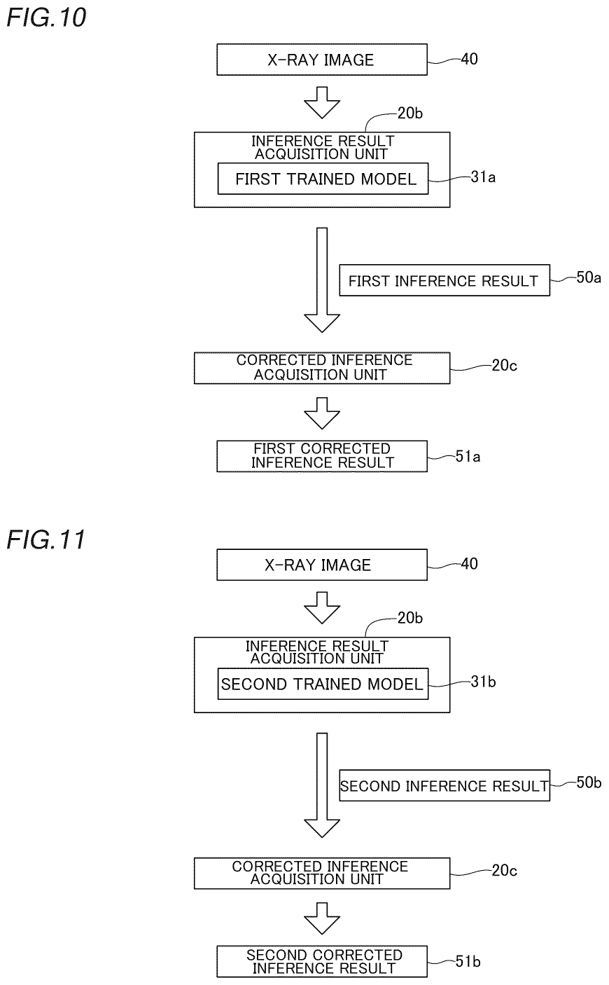

When the inference accuracy of the first trained model 31a decreases, the correction regions 81 occurring in the first inference result 50a increase. Furthermore, when the inference accuracy of the second trained model 31b decreases, the correction regions 81 occurring in the second inference result 50b increase. Therefore, in the present embodiment, the corrected inference result acquisition unit 20c (see FIG. 3) is configured to obtain a first corrected inference result 51a (see FIG. 10) from the first inference result 50a (see FIG. 10). The corrected inference result acquisition unit 20c is also configured to obtain a second corrected inference result 51b (see FIG. 11) from the second inference result 50b (see FIG. 11). The first corrected inference result 51a is an example of the “corrected inference result” in the claims.

### (Acquisition of First Corrected Inference Result)

First, with reference to FIG. 10, a configuration in which the inference result acquisition unit 20b and the corrected inference result acquisition unit 20c obtain the first corrected inference result 51a from the X-ray image 40 will be described.

The inference result acquisition unit 20b obtains a first inference result 50a of the region of the inspection object 90 by inputting the X-ray image 40 into the first trained model 31a, for any X-ray image 40 of the plurality of types of inspection objects 90 (see FIG. 2).

Thereafter, the corrected inference result acquisition unit 20c obtains a first corrected inference result 51a by correcting the first inference result 50a based on a user's operation input entered via the operation unit 23 (see FIG. 1).

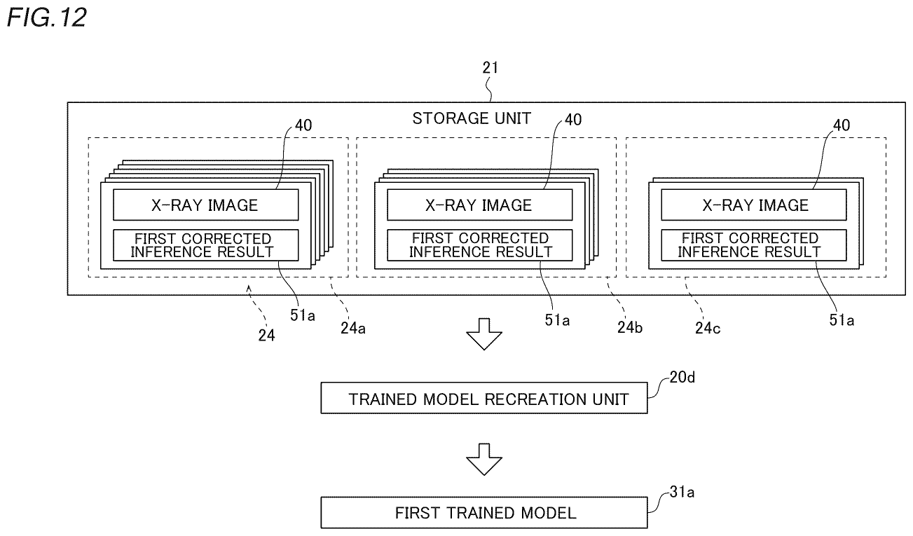

Then, the control unit 20 accumulates and stores the first corrected inference results 51a for the plurality of types of inspection objects 90 in association with their respective X-ray images 40. The control unit 20, for example, accumulates and stores the first corrected inference result 51a and the X-ray image 40 in association using a folder structure and stores them in the storage unit 21 (see FIG. 1). That is, the control unit 20 creates a folder 24 (see FIG. 12) for each type of inspection object 90, and stores the first corrected inference result 51a and the X-ray image 40 in the created folder 24. When obtaining the first inference result 50a using the first trained model 31a, information specifying the type of the inspection object 90 (e.g., the part number of the substrate 91 (see FIG. 2), etc.) is input by the user. Therefore, the control unit 20 can accumulate and store the first corrected inference result 51a in association with the X-ray image 40 for each type of inspection object 90 based on the information specifying the type of the inspection object 90.

### (Acquisition of Second Corrected Inference Result)

Next, with reference to FIG. 11, a configuration in which the inference result acquisition unit 20b and the corrected inference result acquisition unit 20c obtain the second corrected inference result 51b from the X-ray image 40 will be described.

The inference result acquisition unit 20b obtains a second inference result 50b, which is the inference result 50 output from the second trained model 31b, by inputting the X-ray image 40 of a specific type of inspection object 90 into the second trained model 31b.

Thereafter, the corrected inference result acquisition unit 20c obtains a second corrected inference result 51b by correcting the second inference result 50b based on a user's input entered via the operation unit 23 (see FIG. 1).

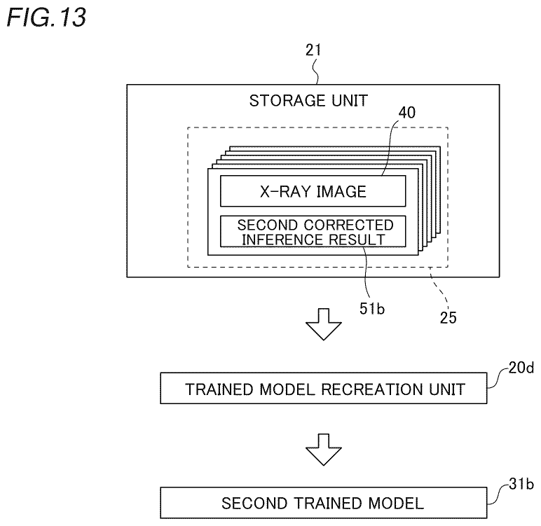

Then, the control unit 20 accumulates and stores the second corrected inference result 51b of the specific type of inspection object 90 in association with the X-ray image 40. The control unit 20, for example, accumulates and stores the second corrected inference result 51b and the X-ray image 40 in association using a folder structure and stores them in the storage unit 21 (see FIG. 1). That is, the control unit 20 creates a folder 25 (see FIG. 13) for each type of inspection object 90, and stores the second corrected inference result 51b and the X-ray image 40 in the created folder 25. When obtaining the second inference result 50b using the second trained model 31b, information specifying the type of the inspection object 90 (e.g., the part number of the substrate 91 (see FIG. 2), etc.) is input by the user. Therefore, the control unit 20 accumulates and stores the second corrected inference result 51b in association with the X-ray image 40 for each type of inspection object 90 based on the information specifying the type of the inspection object 90.

When a certain period of time has passed since the first trained model 31a was first created, the trend in the types of electronic components 92 (see FIG. 2) and the like mounted on the substrate 91 (see FIG. 2), which is the inspection object 90, may change due to market changes and the like. In this case, the inference accuracy of the first inference result 50a by the first trained model 31a decreases due to the change between the trend in the types of electronic components 92 and the like mounted on the substrate 91 at the time the first trained model 31a was first created, and the trend in the types of electronic components 92 and the like mounted on the substrate 91 shown in the X-ray image 40 at the time of actual inspection.

Furthermore, when a certain period of time has passed since the second trained model 31b was first created, even if the same type of inspection object 90 is imaged, the inference accuracy of the second inference result 50b by the second trained model 31b decreases due to changes in the contrast of the captured X-ray image 40, etc., caused by age-related deterioration of the X-ray irradiation unit 10, etc. Also, if the age-deteriorated X-ray irradiation unit 10 is replaced, even if the same type of inspection object 90 is imaged, a change in contrast occurs between the X-ray image used as training data when the second trained model 31b was first created and the X-ray image 40 to be actually inspected. In this case as well, the inference accuracy of the second inference result 50b by the second trained model 31b decreases.

Therefore, the trained model recreation unit 20d (see FIG. 3) recreates the first trained model 31a. The trained model recreation unit 20d also recreates the second trained model 31b.

### (Recreation of First Trained Model)

With reference to FIG. 12, a configuration in which the trained model recreation unit 20d recreates the first trained model 31a will be described.

The trained model recreation unit 20d recreates the first trained model 31a using the associatedly stored X-ray images 40 and first corrected inference results 51a for a plurality of types of inspection objects 90.

A folder 24a is a folder for storing X-ray images 40 and first corrected inference results 51a showing type A inspection objects 90 among the inspection objects 90. A folder 24b is a folder for storing X-ray images 40 and first corrected inference results 51a showing type B inspection objects 90 among the inspection objects 90. A folder 24c is a folder for storing X-ray images 40 and first corrected inference results 51a showing type C inspection objects 90 among the inspection objects 90. In the example shown in FIG. 12, the type A inspection object 90 has been inspected six times. The type B inspection object 90 has been inspected four times. The type C inspection object 90 has been inspected twice. Although the example in FIG. 12 shows a configuration where the X-ray images 40 and the first corrected inference results 51a are stored in association by separating folders 24 for three types of inspection objects 90, in reality, folders 24 are separated for many types of inspection objects 90, three or more, and the X-ray images 40 and the first corrected inference results 51a are stored in association and accumulated for each.

In the present embodiment, the trained model recreation unit 20d recreates the first trained model 31a based on the first corrected inference results 51a and the X-ray images 40 that are accumulated and stored in the storage unit 21 for each type of inspection object 90. Specifically, the trained model recreation unit 20d recreates the first trained model 31a using the X-ray images 40 and the first corrected inference results 51a for a predetermined number of types of inspection objects 90 from the top in descending order of the number of times the process of obtaining the first inference result 50a has been executed, among the plurality of types of inspection objects 90. For example, when recreating the first trained model 31a based on the top two inspection objects 90, the first trained model 31a is recreated using one set of the X-ray image 40 and the first corrected inference result 51a stored in the folder 24a, and one set of the X-ray image 40 and the first corrected inference result 51a stored in the folder 24b. The number of top ranks of the number of times the process of obtaining the first inference result 50a was executed to use the X-ray images 40 and the corresponding first corrected inference results 51a can be changed by the user.

In the present embodiment, when recreating the first trained model 31a, the trained model recreation unit 20d recreates the first trained model 31a based on the first corrected inference results 51a and the X-ray images 40, without using the training data from when the first trained model 31a was first created.

Furthermore, in the present embodiment, the trained model recreation unit 20d performs weighting on the number of X-ray images 40 and first corrected inference results 51a used for recreation, according to the number of times the process of obtaining the first inference result 50a has been executed, and recreates the first trained model 31a based on the X-ray images 40 and the first corrected inference results 51a after the weighting. When performing weighting according to the number of times the process of obtaining the first inference result 50a has been executed, as the rank of the said number of times decreases, the number of X-ray images 40 and the number of corresponding first corrected inference results 51a used for recreating the first trained model 31a are reduced. For example, when recreating the first trained model 31a using the X-ray images 40 showing the top two inspection objects 90 in terms of the number of times the process of obtaining the first inference result 50a has been executed, and the corresponding first corrected inference results 51a, two X-ray images 40 and two corresponding first corrected inference results 51a are used for the first-ranked inspection object 90. Also, one X-ray image 40 and one corresponding first corrected inference result 51a are used for the second-ranked inspection object 90.

The recreated first trained model 31a is accumulated and stored in the storage unit 21. That is, the recreated first trained model 31a is stored separately from the first trained model 31a already stored in the storage unit 21. In other words, the first trained model 31a stored in the storage unit 21 is not overwritten by the new, recreated first trained model 31a. When accumulating and storing the first trained model 31a, it is stored in association with a trained model creation date and time 60 (see FIG. 1).

### (Recreation of Second Trained Model)

Next, with reference to FIG. 13, a configuration in which the trained model recreation unit 20d recreates the second trained model 31b will be described.

The trained model recreation unit 20d recreates the second trained model 31b using the X-ray images 40 and the second corrected inference results 51b for a specific type of inspection object 90. Specifically, the trained model recreation unit 20d recreates the second trained model 31b based on the second corrected inference results 51b and the X-ray images 40 that are accumulated and stored in the storage unit 21 for each type of inspection object 90.

In the present embodiment, the trained model recreation unit 20d recreates the second trained model 31b using at least the latest X-ray image 40 and second corrected inference result 51b. Specifically, the trained model recreation unit 20d recreates the second trained model 31b using one latest X-ray image 40 and one second corrected inference result 51b corresponding to the latest X-ray image 40. That is, in the present embodiment, when recreating the second trained model 31b, the trained model recreation unit 20d recreates the second trained model 31b based on the second corrected inference result 51b and the X-ray image 40, without using the training data from when the second trained model 31b was first created.

The recreated second trained model 31b is accumulated and stored in the storage unit 21. That is, the recreated second trained model 31b is stored separately from the second trained model 31b already stored in the storage unit 21. In other words, the second trained model 31b stored in the storage unit 21 is not overwritten by the new, recreated second trained model 31b. When accumulating and storing the second trained model 31b, it is stored in association with a trained model creation date and time 60 (see FIG. 1).

### (Display of Recreation Promotion Information)

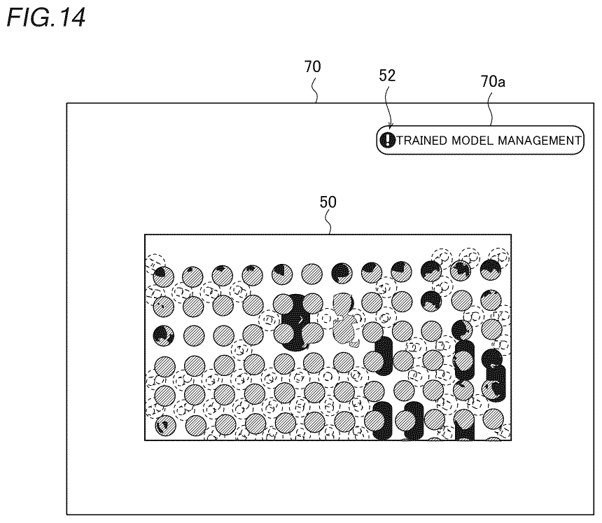

FIG. 14 is an inference result display screen 70 for displaying an inference result 50. The inference result display screen 70 is displayed on the display unit 22 (see FIG. 1).

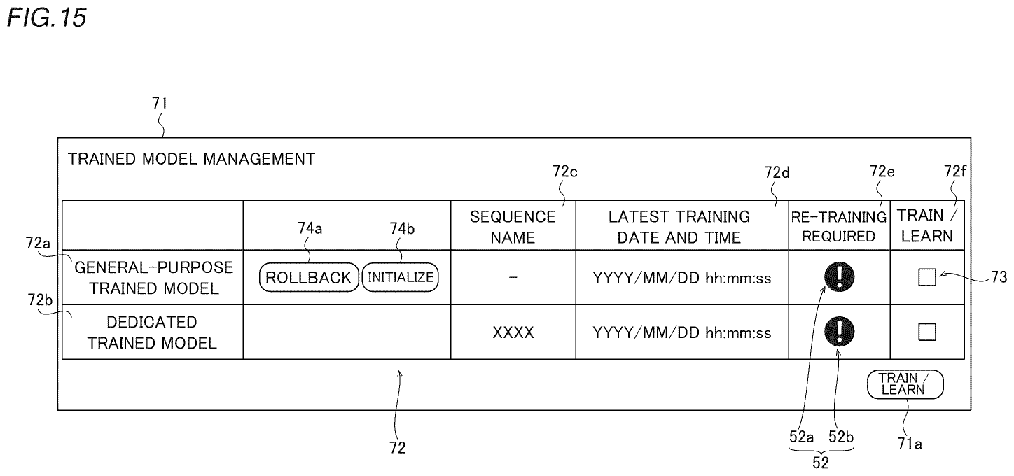

On the inference result display screen 70, the inference result 50 and a trained model management button 70a for displaying a trained model management screen 71 (see FIG. 15), to be described later, are displayed.

The trained model management button 70a is a GUI (Graphical User Interface) push button displayed on the inference result display screen 70.

When the trained model management button 70a is pressed, the control unit 20 (see FIG. 3) displays a trained model management screen 71 shown in FIG. 15.

The trained model management screen 71 is a screen for displaying information related to the first trained model 31a (see FIG. 1) and the second trained model 31b (see FIG. 1). The trained model management screen 71 is also a screen for recreating the first trained model 31a and the second trained model 31b. The trained model management screen 71 is displayed on the display unit 22 (FIG. 1).

As shown in FIG. 15, on the trained model management screen 71, a training button 71a and a display field 72 for displaying management information of the trained model 31 are displayed. The training button 71a is a GUI push button displayed on the trained model management screen 71.

The display field 72 includes a general-purpose trained model display field 72a and a dedicated trained model display field 72b.

The general-purpose trained model display field 72a is a display field for displaying information on the first trained model 31a. The dedicated trained model display field 72b is a display field for displaying information on the second trained model 31b.

The display field 72 also includes a sequence name display field 72c, a latest training date and time display field 72d, a recreation promotion information display field 72e, and a checkbox display field 72f.

In the sequence name display field 72c, the analysis name for when analysis is performed using the trained model 31 is displayed. Since the first trained model 31a is a general-purpose trained model, the sequence name display field 72c does not display an analysis name.

In the latest training date and time display field 72d, the date and time when the trained model 31 was last regenerated are displayed. Specifically, in the latest training date and time display field 72d, based on the trained model creation date and time 60 stored in the storage unit 21 (see FIG. 1), the year, month, day, hour, minute, and second of when the trained model 31 was last regenerated are displayed. For each of the first trained model 31a and the second trained model 31b, the year, month, day, hour, minute, and second of when they were last regenerated are displayed in the latest training date and time display field 72d. If the trained model 31 has never been recreated, the year, month, day, hour, minute, and second of when the trained model 31 was first created are displayed in the latest training date and time display field 72d.

In the recreation promotion information display field 72e, recreation promotion information 52 is displayed. The recreation promotion information 52 includes first recreation promotion information 52a and second recreation promotion information 52b. The first recreation promotion information 52a is information that promotes the recreation of the first trained model 31a. The second recreation promotion information 52b is information that promotes the recreation of the second trained model 31b.

When the recreation of the first trained model 31a is necessary, the first recreation promotion information 52a is displayed. When the recreation of the second trained model 31b is necessary, the second recreation promotion information 52b is displayed. The display of the first recreation promotion information 52a and the second recreation promotion information 52b is performed by the display control unit 20g (see FIG. 3).

The display control unit 20g determines whether recreation of the first trained model 31a is necessary based on whether a predetermined period 61 has elapsed since the last recreation of the first trained model 31a. Specifically, the display control unit 20g determines whether to display the first recreation promotion information 52a by comparing the elapsed period since the last recreation of the first trained model 31a, obtained by the recreation period acquisition unit 20e (see FIG. 3), with the predetermined period 61. That is, if the elapsed period since the last recreation of the first trained model 31a, obtained by the recreation period acquisition unit 20e, is longer than the predetermined period 61, the display control unit 20g determines that recreation of the first trained model 31a is necessary. The predetermined period 61 is, for example, half a year or one year. The predetermined period 61 is stored in the storage unit 21 and can be changed by a user's operation input.

The recreation period acquisition unit 20e obtains the elapsed period from the creation date and time of the first trained model 31a in the trained model creation date and time 60 stored in the storage unit 21 (see FIG. 1) to the present time.

The display control unit 20g determines whether recreation of the second trained model 31b is necessary based on whether the correction amount of the second inference result 50b has reached or exceeded a predetermined amount. Specifically, the display control unit 20g determines whether recreation of the second trained model 31b is necessary based on whether the correction amount of the second inference result 50b is greater than or equal to a threshold value 62 (see FIG. 1). That is, when the correction amount of the second inference result 50b becomes greater than or equal to the threshold value 62, the display control unit 20g determines that recreation of the second trained model 31b is necessary.

The correction amount of the second inference result 50b is obtained by the correction amount acquisition unit 20f. Specifically, the correction amount acquisition unit 20f obtains the correction amount of the second inference result 50b based on the second inference result 50b and the second corrected inference result 51b. More specifically, the correction amount acquisition unit 20f obtains the correction amount of the second inference result 50b by taking the difference between the second corrected inference result 51b and the second inference result 50b.

As shown in FIG. 15, the recreation promotion information 52 is an icon. Although the trained model management screen 71 in FIG. 15 shows an example where both the first recreation promotion information 52a and the second recreation promotion information 52b are displayed, if the elapsed period since the last recreation of the first trained model 31a is not more than the predetermined period 61, the first recreation promotion information 52a is not displayed. If the correction amount of the second inference result 50b is less than the threshold value 62, the second recreation promotion information 52b is not displayed. Furthermore, when either the first recreation promotion information 52a or the second recreation promotion information 52b is displayed, the recreation promotion information 52 is also displayed on the trained model management button 70a of the inference result display screen 70 shown in FIG. 14.

In the checkbox display field 72f, a checkbox 73 is displayed. When the training button 71a is pressed with the checkbox 73 checked, the trained model recreation unit 20d recreates the corresponding trained model 31. That is, when the training button 71a is pressed with the checkbox 73 in the general-purpose trained model display field 72a checked, the trained model recreation unit 20d recreates the first trained model 31a. When the training button 71a is pressed with the checkbox 73 in the dedicated trained model display field 72b checked, the trained model recreation unit 20d recreates the second trained model 31b.

Furthermore, in the general-purpose trained model display field 72a, a rollback button 74a and an initialization button 74b are displayed. Each of the rollback button 74a and the initialization button 74b is a GUI push button.

When the rollback button 74a is pressed, the control unit 20 performs a process to revert the first trained model 31a to the previous first trained model 31a.

When the initialization button 74b is pressed, the control unit 20 performs a process to revert the first trained model 31a to the first trained model 31a that was initially created.

### (First Trained Model Recreation Process)

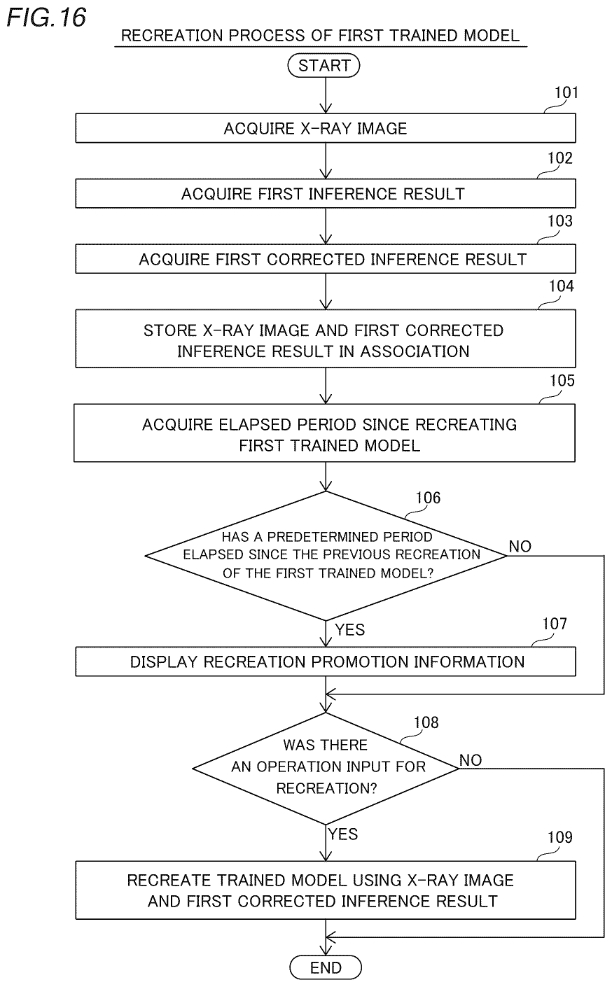

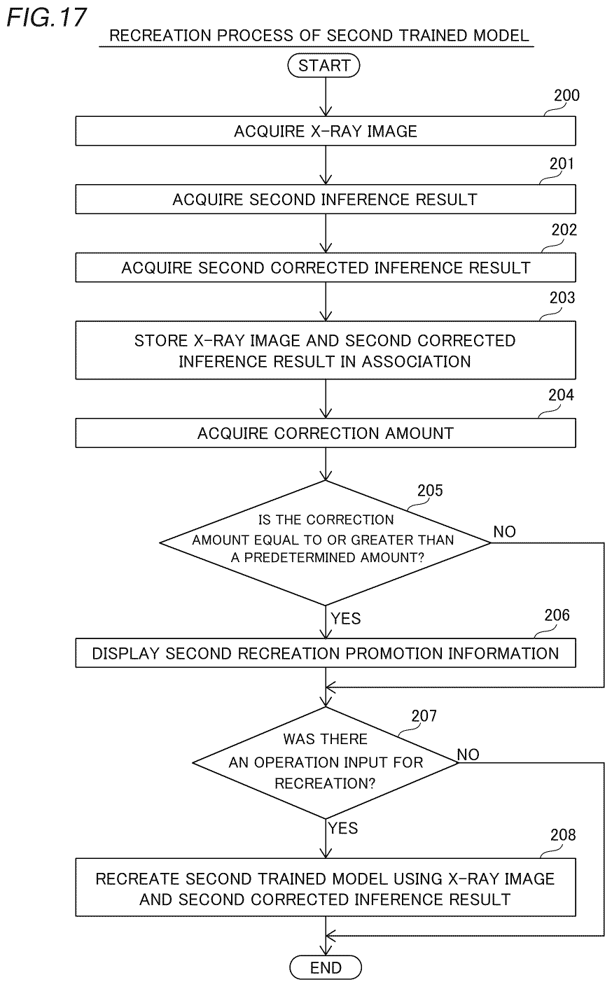

Next, with reference to FIG. 16, a process in which the control unit 20 (see FIG. 1) recreates the first trained model 31a (see FIG. 1) will be described. The process of recreating the first trained model 31a shown in FIG. 16 is performed by the control unit 20 executing the program 30 (see FIG. 1) stored in the storage unit 21 (see FIG. 1).

In step 101, the control unit 20 acquires an X-ray image 40 (see FIG. 1).

Next, in step 102, the inference result acquisition unit 20b (see FIG. 3) obtains an inference result 50 (see FIG. 6) of the region of the inspection object 90, which is obtained by inputting the X-ray image 40 into the trained model 31. In the present embodiment, the inference result acquisition unit 20b obtains a first inference result 50a (see FIG. 10) of the corresponding inspection object 90 by inputting an X-ray image 40 showing any one of the plurality of types of inspection objects 90 into the first trained model 31a.

Next, in step 103, the corrected inference result acquisition unit 20c (see FIG. 3) obtains a corrected inference result 51 (see FIG. 9) by correcting the inference result 50 based on a user's operation input. In the present embodiment, the corrected inference result acquisition unit 20c obtains a first corrected inference result 51a (see FIG. 10) by correcting the first inference result 50a based on a user's operation input.

Next, in step 104, the control unit 20 stores the acquired corrected inference result 51 in association with the X-ray image 40. In the present embodiment, the control unit 20 accumulates and stores the acquired first corrected inference result 51a in association with the X-ray image 40 for each type of inspection object 90. Specifically, each time a corrected inference result 51 is acquired, the control unit 20 accumulates and stores the corrected inference result 51 and the X-ray image 40 for each type of inspection object 90.

Next, in step 105, the recreation period acquisition unit 20e (see FIG. 3) obtains the elapsed period from the recreation date and time of the first trained model 31a to the present time. Specifically, the recreation period acquisition unit 20e obtains the elapsed period from the last recreation date and time of the first trained model 31a to the present time, based on the current date and time information and the date and time information of the last recreation of the first trained model 31a included in the trained model creation date and time 60 stored in the storage unit 21 (see FIG. 1).

Next, in step 106, the control unit 20 determines whether to display the recreation promotion information 52 (see FIG. 15). Specifically, the display control unit 20g (see FIG. 3) determines whether the elapsed period since the last recreation of the first trained model 31a has exceeded a predetermined period 61 (see FIG. 1). More specifically, the display control unit 20g compares the elapsed period obtained by the recreation period acquisition unit 20e with the predetermined period 61. If the elapsed period is longer than the predetermined period 61, the display control unit 20g determines that the predetermined period 61 has elapsed since the last recreation of the first trained model 31a. If the predetermined period 61 has elapsed since the last recreation of the first trained model 31a, the process proceeds to step 107. If the predetermined period 61 has not elapsed since the last recreation of the first trained model 31a, the process proceeds to step 108.

If the process proceeds from step 106 to step 107, that is, if it is determined that the elapsed period has exceeded the predetermined period 61, then in step 107, the display control unit 20g displays the recreation promotion information 52 that promotes the recreation of the trained model 31. That is, the display control unit 20g displays the first recreation promotion information 52a after the predetermined period 61 has elapsed since the last recreation of the first trained model 31a.

Next, in step 108, the control unit 20 determines whether there has been an operation input to recreate the trained model 31. Specifically, the control unit 20 determines whether the training button 71a has been pressed with the checkbox 73 in the general-purpose trained model display field 72a checked on the trained model management screen 71 shown in FIG. 15. If the training button 71a has been pressed with the checkbox 73 in the general-purpose trained model display field 72a checked, the process proceeds to step 109. If the training button 71a is pressed without the checkbox 73 in the general-purpose trained model display field 72a being checked, or if the training button 71a is not pressed, the process ends.

If the process proceeds from step 108 to step 109, then in step 109, the trained model recreation unit 20d recreates the first trained model 31a using the associatedly stored X-ray images 40 and corrected inference results 51 for the plurality of types of inspection objects 90. Specifically, the trained model recreation unit 20d recreates the first trained model 31a using the X-ray images 40 and the first corrected inference results 51a that are accumulated and stored for each type of inspection object 90. In the present embodiment, the inspection object 90 is a solder ball 93. Therefore, in step 108, the trained model recreation unit 20d recreates the first trained model 31a that outputs the solder ball region 80a as the first inference result 50a, with the X-ray image 40 as input data.

Note that in step 108, the trained model recreation unit 20d recreates the first trained model 31a that outputs the first inference result 50a as training data for creating the second trained model 31b, with the X-ray image 40 as input data. The types of inspection objects 90 of the first corrected inference results 51a used for recreation in step 108 are different from the types of inspection objects 90 of the first corrected inference results 51a used for the creation of the previous first trained model 31a.

Furthermore, in the process of step 108 in the present embodiment, the trained model recreation unit 20d recreates the first trained model 31a using the X-ray images 40 and the first corrected inference results 51a for a predetermined number of types of inspection objects 90 from the top in descending order of the number of times step 109 of obtaining the first inference result 50a has been executed, among the plurality of types of inspection objects 90. Specifically, the trained model recreation unit 20d recreates the first trained model 31a using the X-ray images 40 and the first corrected inference results 51a for a predetermined number of types of inspection objects 90 from the top in descending order of the number of times step 109 of obtaining the first inference result 50a has been executed from the present to a predetermined period ago, among the plurality of types of inspection objects 90. The trained model recreation unit 20d also performs weighting on the number of X-ray images 40 and first corrected inference results 51a used for recreation according to the number of times step 109 of obtaining the first inference result 50a has been executed, and recreates the first trained model 31a based on the X-ray images 40 and the first corrected inference results 51a after the weighting.

### (Second Trained Model Recreation Process)

Next, with reference to FIG. 17, a process in which the control unit 20 (see FIG. 3) recreates the second trained model 31b (see FIG. 1) will be described. The process of recreating the second trained model 31b shown in FIG. 17 is performed by the control unit 20 executing the program 30 (see FIG. 1) stored in the storage unit 21 (see FIG. 1).

In step 200, the control unit 20 acquires an X-ray image 40 (see FIG. 4).

Next, in step 201, the inference result acquisition unit 20b (see FIG. 3) obtains a second inference result 50b (see FIG. 11), which is an inference result 50 output from the second trained model 31b. Specifically, the inference result acquisition unit 20b obtains the second inference result 50b of the inspection object 90 by inputting the X-ray image 40 of a specific type of inspection object 90 into the second trained model 31b.

Next, in step 202, the corrected inference result acquisition unit 20c (see FIG. 3) obtains a second corrected inference result 51b (see FIG. 11) by correcting the second inference result 50b based on a user's input.

Next, in step 202, the control unit 20 accumulates and stores the second corrected inference result 51b of the specific type of inspection object 90 in association with the X-ray image 40.

Next, in step 204, the correction amount acquisition unit 20f (see FIG. 3) obtains the correction amount of the second inference result 50b based on the second inference result 50b and the second corrected inference result 51b, which is the second inference result 50b corrected based on the user's input.

Next, in step 205, the display control unit 20g (see FIG. 3) determines whether to display the second recreation promotion information 52b (see FIG. 15). Specifically, the display control unit 20g determines whether the correction amount of the second inference result 50b, obtained by the correction amount acquisition unit 20f, has reached or exceeded a predetermined amount. More specifically, the display control unit 20g determines whether the correction amount of the second inference result 50b has reached or exceeded a predetermined amount based on whether the correction amount of the second inference result 50b is greater than or equal to a threshold value 62 (see FIG. 1). If the correction amount of the second inference result 50b is greater than or equal to the threshold value 62, the process proceeds to step 206. If the correction amount of the second inference result 50b is less than the threshold value 62, the process proceeds to step 207.

If the process proceeds from step 205 to step 206, then in step 206, the display control unit 20g displays the second recreation promotion information 52b. In other words, the display control unit 20g displays the second recreation promotion information 52b when the correction amount has reached or exceeded the predetermined amount.

Next, in step 207, the control unit 20 determines whether there has been an operation input to recreate the trained model 31. Specifically, the control unit 20 determines whether the training button 71a has been pressed with the checkbox 73 in the dedicated trained model display field 72b checked on the trained model management screen 71 shown in FIG. 15. If the training button 71a has been pressed with the checkbox 73 in the dedicated trained model display field 72b checked, the process proceeds to step 208. If the training button 71a is pressed without the checkbox 73 in the dedicated trained model display field 72b being checked, or if the training button 71a is not pressed, the process ends.

Next, in step 208, the trained model recreation unit 20d recreates the second trained model 31b using the X-ray image 40 and the second corrected inference result 51b for the specific type of inspection object 90. Thereafter, the process ends.

### [Modifications]

The embodiments and examples disclosed herein should be considered as illustrative in all respects and not restrictive. The scope of the present invention is indicated by the claims rather than by the description of the embodiments and examples above, and all modifications (variations) within the meaning and scope equivalent to the claims are included.

For example, the storage control unit may be configured to, each time a corrected inference result is acquired, overwrite the corrected inference result and the X-ray image stored in the storage unit with the latest corrected inference result and X-ray image, that is, to store only the latest corrected inference result and X-ray image. For example, the control unit may not be configured to display the recreation promotion information. For example, the control unit may be configured to recreate the first trained model based on the X-ray images and the first corrected inference results for all types of inspection objects. For example, the control unit may be configured to recreate the first trained model using one X-ray image and one corrected inference result for each of the higher-ranked inspection objects according to the number of times the process of obtaining the first inference result was executed, without performing weighting on the number of X-ray images and first corrected inference results used for recreation according to the number of times the process of obtaining the first inference result was executed and the type of inspection object. For example, the control unit may be configured to recreate the second trained model using training data that includes the latest second corrected inference result and X-ray image, as well as second corrected inference results and X-ray images other than the latest ones. That is, the control unit may be configured to recreate the second trained model based on one latest X-ray image and one corresponding latest second corrected inference result, and one or more X-ray images other than the latest and one or more corresponding second corrected inference results other than the latest.

Furthermore, for example, in FIG. 16, steps 107 and 108 may be omitted, and the first trained model may be recreated when a predetermined period has elapsed without displaying the first recreation promotion information and inquiring of the user.

Furthermore, for example, in FIG. 17, steps 205 and 206 may be omitted, and the second trained model may be recreated when the correction amount reaches or exceeds a predetermined amount without displaying the second recreation promotion information and inquiring of the user.

Furthermore, for example, when recreating the first trained model, the control unit may be configured to recreate the first trained model using the training data from when the first trained model was first created, and the first corrected inference results and X-ray images. In this case, since the types of training data increase, the versatility of the first trained model improves. However, it may become impossible to respond to changes in the trend of the types of inspection objects, and the inference accuracy of the first trained model may decrease. That is, when including the training data from when the first trained model was first created in the training data for recreating the first trained model, there is a trade-off relationship between versatility and inference accuracy. For example, when recreating the second trained model, the control unit may be configured to recreate the second trained model using the training data from when the second trained model was first created, and the second corrected inference results and X-ray images. However, if the inference accuracy of the second trained model is decreasing due to age-related deterioration of the X-ray irradiation unit or the like, or replacement of the age-deteriorated X-ray irradiation unit or the like, recreating the second trained model using training data that includes the training data from when the second trained model was first created may not improve the inference accuracy of the second trained model. Therefore, it is preferable that the control unit is configured to recreate the second trained model using the second corrected inference results and the X-ray images, without using the training data from when the second trained model was first created.

Furthermore, for example, the X-ray image may be an image showing an inspection object other than solder balls. In this case, the trained model may be configured to perform image transformation that can distinguish a region where an inspection object other than solder balls is shown from other regions in the X-ray image. For example, the trained model may be configured to perform image transformation that can distinguish a region of a plurality of solder materials at the connection parts of a plurality of terminals of an LGA (Land Grid Array) in which terminals are arranged in a grid pattern, from other regions. The trained model may also perform image transformation that can distinguish a region of a plurality of terminals from other regions, instead of the solder material.

Furthermore, for example, the present invention can also be applied to a configuration in which a plurality of solder balls are arranged side by side on both the front and back surfaces of a substrate.

### [Aspects]

Those skilled in the art will understand that the exemplary embodiments described above are specific examples of the following aspects.

### (Item 1)

A method for recreating a trained model for acquiring a region of an inspection object from an X-ray image of the inspection object,
wherein the trained model is a general-purpose trained model corresponding to a plurality of types of the inspection objects,
the method comprising:
a step of acquiring the X-ray image;
a step of obtaining a first inference result of the region of the inspection object by inputting the X-ray image into the first trained model for any X-ray image of the plurality of types of the inspection objects;
a step of obtaining a first corrected inference result by correcting the first inference result based on a user's operation input;
a step of storing the first corrected inference result for the plurality of types of the inspection objects in association with each of the X-ray images; and
a step of recreating the first trained model using the associatedly stored X-ray images and the first corrected inference results for the plurality of types of the inspection objects.

Since the first inference result contains some errors, appropriate correction by user operation is necessary. By storing this first corrected inference result, the stored first corrected inference result can be used to recreate the first trained model. In other words, the execution of the inspection of the inspection object also serves as the creation of training data necessary for recreating a new first trained model. Therefore, the user is not required to separately perform the task of creating training data necessary for recreating a new first trained model, and the first trained model can be recreated while reducing the burden on the user.

The first trained model is a general-purpose trained model, which is created by inputting a plurality of types of inspection objects as training data. However, since the types of inspection objects that the user inspects may change over time (the trend changes), the accuracy of the first inference result by the general-purpose trained model (first trained model) decreases. However, in the present invention, the first corrected inference results for a plurality of types of inspection objects are stored, and the first trained model is recreated using the plurality of types of stored first corrected inference results. Since the first corrected inference results used for recreation are for a plurality of types of inspection objects for which the process of outputting the first inference result was actually executed (i.e., the inspection was executed), the recreated general-purpose trained model is considered to be more suitable for the plurality of types of inspection objects that the user will continue to inspect. Therefore, by using the recreated general-purpose trained model, the accuracy of the inference result can be improved.

### (Item 2)

The method for recreating a trained model according to item 1, wherein, in the recreating step, the first trained model is recreated using the X-ray images and the first corrected inference results for a predetermined number of types of the inspection objects from the top in descending order of the number of times the step of obtaining the first inference result has been executed, among the plurality of types of the inspection objects.

In this case, the plurality of types of inspection objects used for recreating the general-purpose trained model are limited to the types for which the user has actually output the first inference result using the general-purpose trained model a large number of times, and types for which the user has not output the first inference result using the general-purpose trained model a large number of times are excluded. Therefore, the recreated general-purpose trained model will be trained focusing on the types for which the user has actually output the first inference result using the general-purpose trained model a large number of times, making it even more suitable for the plurality of types of inspection objects that the user will continue to inspect.

### (Item 3)

The method for recreating a trained model according to item 1, wherein, in the recreating step, the first trained model is recreated using the X-ray images and the first corrected inference results for a predetermined number of types of the inspection objects from the top in descending order of the number of times the step of obtaining the first inference result has been executed from the present to a predetermined period ago, among the plurality of types of the inspection objects.

In this case, the plurality of types of inspection objects used for recreating the general-purpose trained model are limited to the types for which the user has actually output the first inference result using the general-purpose trained model a large number of times from the present to a predetermined period ago. Therefore, the recreated general-purpose trained model will be trained focusing on the types for which the user has recently actually output the first inference result using the general-purpose trained model a large number of times, making it even more suitable for the plurality of types of inspection objects that the user will continue to inspect.

### (Item 4)

The method for recreating a trained model according to item 2, wherein, in the recreating step, weighting is performed on the number of the X-ray images and the first corrected inference results used for recreating the first trained model according to the number of times the step of obtaining the first inference result has been executed, and the first trained model is recreated using the X-ray images and the first corrected inference results after the weighting.

In this case, for the types of inspection objects for which the user has actually output the first inference result using the general-purpose trained model a larger number of times, a larger weight is set, and conversely, for the types of inspection objects for which the user has actually output the first inference result using the general-purpose trained model a smaller number of times, a smaller weight is set. Therefore, the recreated general-purpose trained model can have a greater influence on the training for the types of inspection objects for which the user has actually output the first inference result using the general-purpose trained model a larger number of times, making it even more suitable for the plurality of types of inspection objects that the user will continue to inspect.

### (Item 5)

The method for recreating a trained model according to item 1, wherein, in the recreating step, it is determined whether an elapsed period since the last time the first trained model was recreated has exceeded a predetermined period, and if it is determined to have exceeded, the first trained model is recreated using the X-ray images and the first corrected inference results for the plurality of types of the inspection objects.

The longer the elapsed period since the last time the general-purpose trained model was created, the higher the possibility that the types of inspection objects the user inspects will change (the trend will change). Therefore, in the present invention, by recreating the first trained model when a predetermined period has elapsed since the last recreation of the general-purpose trained model, it becomes possible to use a first trained model that is suitable for the types of inspection objects for which the user has recently actually output the first inference result using the general-purpose trained model.

### (Item 6)

The method for recreating a trained model according to item 1, wherein the types of the inspection objects of the first corrected inference results used for the recreation are different from the types of the inspection objects of the first corrected inference results used for the creation of the previous first trained model.

Since the types of inspection objects of the first corrected inference results used for recreation are different from the types of inspection objects of the first corrected inference results used for the creation of the previous first trained model, it becomes possible to use a trained model that is suitable for the types of inspection objects for which the user has recently actually output an inference result using the general-purpose trained model.

### (Item 7)

The method for recreating a trained model according to item 1, further comprising a dedicated second trained model corresponding only to a specific one type of the inspection object among the plurality of types of the inspection objects,
the method further comprising:
a step of obtaining a second inference result of the inspection object by inputting the X-ray image of the specific type of the inspection object into the second trained model;
a step of obtaining a second corrected inference result by correcting the second inference result based on a user's operation input;
a step of storing the second corrected inference result of the specific type of the inspection object in association with the X-ray image; and
a step of recreating the second trained model using the X-ray image and the second corrected inference result for the specific type of the inspection object.

Even for a dedicated trained model for a specific type of inspection object, the accuracy of the inference result may change due to age-related deterioration of hardware for acquiring X-ray images, component replacement, or the like. In the present invention, by storing the second corrected inference result for this dedicated trained model as well, the stored second corrected inference result can be used to recreate the dedicated trained model (second trained model). Therefore, by using the recreated dedicated trained model, the accuracy of the second inference result can be improved.

### (Item 8)

The method for recreating a trained model according to item 7, wherein, in the step of recreating the second trained model, it is determined whether a correction amount of the second corrected inference result is a predetermined amount or more, and when it is determined to be the predetermined amount or more, the second trained model is recreated using the X-ray image and the second corrected inference result for the specific type of the inspection object.

The fact that the correction amount of the second corrected inference result is a predetermined amount or more means that the change in the accuracy of the second inference result has become large due to age-related deterioration of hardware for acquiring X-ray images, component replacement, or the like. Therefore, the dedicated trained model (second trained model) can be recreated at an appropriate timing, and the accuracy of the second inference result can be improved.

### (Item 9)

The method for recreating a trained model according to item 1, wherein
the inspection object is a substrate on which a plurality of solder balls are arranged, the X-ray image is an image showing the substrate,
the region of the inspection object is a solder ball region where the plurality of solder balls are shown, and
in the recreating step, the trained model that outputs the solder ball region as the inference result is recreated with the X-ray image as input data.

### (Item 10)

A system for recreating a trained model for acquiring a region of an inspection object from an X-ray image of the inspection object,
wherein the trained model is a general-purpose trained model corresponding to a plurality of types of the inspection objects,
the system comprising:
an X-ray imaging apparatus having an X-ray irradiation unit that irradiates X-rays and an X-ray detector that detects X-rays irradiated from the X-ray irradiation unit; and
an image processing apparatus that generates the X-ray image,
wherein the image processing apparatus performs:
a control to acquire the X-ray image;
a control to obtain an inference result of the region of the inspection object, which is obtained by inputting the X-ray image into the trained model for any X-ray image of the plurality of types of the inspection objects;
a control to obtain a corrected inference result by correcting the inference result based on a user's operation input;
a control to store the acquired corrected inference result for the plurality of types of the inspection objects in association with the X-ray image; and
a control to recreate the trained model using the associatedly stored X-ray images and the corrected inference results for the plurality of types of the inspection objects.

The present invention also provides technical effects similar to those of item 1.

### (Item 11)

A program for recreating a trained model for acquiring a region of an inspection object from an X-ray image of the inspection object,
wherein the trained model is a general-purpose trained model corresponding to a plurality of types of the inspection objects,
the program causing a computer to execute:
a control to acquire the X-ray image;
a control to obtain an inference result of the region of the inspection object, which is obtained by inputting the X-ray image into the trained model for any X-ray image of the plurality of types of the inspection objects;
a control to obtain a corrected inference result by correcting the inference result based on a user's operation input;
a control to store the acquired corrected inference result for the plurality of types of the inspection objects in association with the X-ray image; and
a control to recreate the trained model using the associatedly stored X-ray images and the corrected inference results for the plurality of types of the inspection objects.

The present invention also provides technical effects similar to those of item 1.

### REFERENCE SIGNS LIST

1 X-ray imaging apparatus
2 Image processing apparatus
10 X-ray irradiation unit
11 X-ray detector
20 Control unit
30 Program (Program for recreating a trained model)
31 Trained model
31a First trained model
31b Second trained model
40 X-ray image
50 Inference result
50a First inference result
50b Second inference result
51 Corrected inference result
51a First corrected inference result
51b Second corrected inference result
80a Solder ball region (Region of inspection object)
90 Inspection object
91 Substrate
93 Solder ball
100 Trained model recreation system

1. A method for recreating a trained model for acquiring a region of an inspection object from an X-ray image of said inspection object,
wherein said trained model is a general-purpose first trained model corresponding to a plurality of types of said inspection object,
the method comprising:
a step of acquiring said X-ray image;
a step of obtaining a first inference result of the region of said inspection object by inputting said X-ray image into said first trained model, for any of said X-ray images of the plurality of types of said inspection object;
a step of obtaining a first corrected inference result by correcting said first inference result based on a user's operation input;
a step of storing said first corrected inference result for the plurality of types of said inspection object in association with each of said X-ray images; and
a step of recreating said first trained model using the associatedly stored said X-ray images and said first corrected inference results for the plurality of types of said inspection object.

2. The method for recreating a trained model according to claim 1, wherein in said recreating step, said first trained model is recreated using said X-ray images and said first corrected inference results for a predetermined number of types of said inspection object from the top in descending order of a number of times said step of obtaining the first inference result has been executed, among the plurality of types of said inspection object.

3. The method for recreating a trained model according to claim 1, wherein in said recreating step, said first trained model is recreated using said X-ray images and said first corrected inference results for a predetermined number of types of said inspection object from the top in descending order of a number of times said step of obtaining the first inference result has been executed from a present time to a predetermined period ago, among the plurality of types of said inspection object.

4. The method for recreating a trained model according to claim 2, wherein in said recreating step, weighting is performed on a number of said X-ray images and said first corrected inference results used for recreating said first trained model according to the number of times said step of obtaining the first inference result has been executed, and said first trained model is recreated using said X-ray images and said first corrected inference results after the weighting.

5. The method for recreating a trained model according to claim 1, wherein in said recreating step, it is determined whether an elapsed period since a last time said first trained model was recreated has exceeded a predetermined period, and if it is determined to have exceeded, said first trained model is recreated using said X-ray images and said first corrected inference results for the plurality of types of said inspection object.

6. The method for recreating a trained model according to claim 1, wherein the types of said inspection object of said first corrected inference results used for said recreation are different from the types of said inspection object of said first corrected inference results used for a creation of a previous said first trained model.

7. The method for recreating a trained model according to claim 1, further comprising a dedicated second trained model corresponding only to a specific one type of said inspection object among the plurality of types of said inspection object,
the method further comprising:
a step of obtaining a second inference result of said inspection object by inputting said X-ray image of said specific one type of said inspection object into said second trained model;
a step of obtaining a second corrected inference result by correcting said second inference result based on a user's operation input;
a step of storing said second corrected inference result of said specific one type of said inspection object in association with said X-ray image; and
a step of recreating said second trained model using said X-ray image and said second corrected inference result for said specific one type of said inspection object.

8. The method for recreating a trained model according to claim 7, wherein in said step of recreating the second trained model, it is determined whether a correction amount of said second corrected inference result is a predetermined amount or more, and when it is determined to be the predetermined amount or more, said second trained model is recreated using said X-ray image and said second corrected inference result for said specific one type of said inspection object.

9. The method for recreating a trained model according to claim 1, wherein
said inspection object is a substrate on which a plurality of solder balls are arranged,
said X-ray image is an image showing said substrate,
the region of said inspection object is a solder ball region where said plurality of solder balls are shown, and
in said recreating step, said first trained model that outputs said solder ball region as said first inference result is recreated with said X-ray image as input data.

10. A system for recreating a trained model for acquiring a region of an inspection object from an X-ray image of said inspection object,
wherein said trained model is a general-purpose trained model corresponding to a plurality of types of said inspection object,
the system comprising:
an X-ray imaging apparatus having an X-ray irradiation unit that irradiates X-rays and an X-ray detector that detects X-rays irradiated from said X-ray irradiation unit; and
an image processing apparatus that generates said X-ray image,
wherein said image processing apparatus performs:
a control to acquire said X-ray image;
a control to obtain an inference result of the region of said inspection object, which is obtained by inputting said X-ray image into said trained model for any of said X-ray images of the plurality of types of said inspection object;
a control to obtain a corrected inference result by correcting said inference result based on a user's operation input;
a control to store the acquired said corrected inference result for the plurality of types of said inspection object in association with said X-ray image; and
a control to recreate said trained model using the associatedly stored said X-ray images and said corrected inference result for the plurality of types of said inspection object.
